(19) United States
(12) Patent Application Publication
(10) Pub. No.: US 2013/0254176 A1
(43) Pub. Date: Sep. 26, 2013

(54) Systems and Methods for Generating Search Queries

(71) Applicant: Efstratios Davlos, Cupertino, CA (US)

(72) Inventor: Efstratios Davlos, Cupertino, CA (US)

(73) Assignee: Apple Inc., Cupertino, CA (US)

(21) Appl. No.: 13/426,087

(22) Filed: Mar. 21, 2012

(51) Int. Cl. G06F 17/30; G06F 11/30

(52) U.S. Cl. 707/706; 707/E17.108

(57) ABSTRACT

Systems and methods are provided for monitoring interactions of a user with a search engine, associating the user with a domain based on a purpose for using the search engine, prompting the user to input a query string where the query string includes a sequence of letters, and, in response to receiving one or more letters of the query string from the user, generating a plurality of user selectable search query candidates. The process of generating user selectable search query candidates may include ignoring or blocking a portion of the query string based on a blocking rule set, assigning a query value to each search query of a set of search queries and determining the plurality of search query candidates from the set of search queries based on a range of determined query values.

### FIELD

This application relates to searching data and, more particularly, to generating search queries.

### BACKGROUND

Search engines are typically designed to search for information stored in a database in response to a user query for particular information. A web search engine searches for information on the World Wide Web (WWW) and FTP servers. Search results are typically presented as a list of results on one or more search engine results pages.

Web search engines typically perform functions such as web crawling, data indexing, and information searching. Web search engines gather information about web pages using a web crawler or spider and store the information in a database. The data in the database is typically indexed based on certain information such as titles, headings, metadata, and other fields. Indexing enables a search engine to efficiently find queried information.

When a user enters a query into a search engine, the search engine typically analyzes its index and, in response, provides a listing of best-matching web pages based on certain criteria. Often, a user must repeatedly enter multiple search query strings and review the search engine's responses until a desired or optimal listing is returned to the user. This iterative process of repeatedly submitting search queries and reviewing lists of search results can be time-consuming and inefficient.

### SUMMARY

The application, in various implementations, provides systems, methods and devices that provide a way that enables users to more rapidly and efficiently search for information such as information on the World Wide Web and/or in other data storage mediums. In certain implementations, an intermediate server and/or computer system operates between a user and one or more search engines. The system monitors user interactions and predicts which search queries are relevant and/or desired by the user. The system calculates a query value associated with each of multiple possible search queries that may be relevant or desired by the user, and presents a set of candidate search queries to the user in, for example, a drop down window on a page of the user's web browser. The user can then efficiently select one of the candidate search queries to submit to one or more search engines to enable a more targeted, efficient, and/or desired search

In one aspect, a system for generating search queries includes a computer with a computer readable medium, operatively coupled to the computer. The computer may be a server connected to a network such as an enterprise network and/or the Internet. The computer readable medium storing program codes causes the computer to perform functions such as monitoring interactions of a user with a search engine, associating the user with a domain based on a purpose for using the search engine, and prompting the user to input a query string where the query string includes a sequence of letters.

In response to receiving one or more letters of the query string from the user, the computer system generates one or more user selectable search query candidates where the generation includes assigning a query value to each search query of a set of search queries based at least in part on the user interactions with the search engine, a bias assigned to each search query, and the domain of the user. The generation also includes determining the one or more search query candidates from the set of search queries based on a range of determined query values. The range may include a set of search queries having the highest query values such as, for example, the queries values with the highest 1, 2, 3, 5, 8, 10, and so on, values.

In one configuration, the computer system receives a user selection of one of the multiple user selectable search query candidates. The computer system may then provide the user selection to the search engine. The computer may receive one or more search results from the search engine and displays a portion of the search results to the user. The computer system may assign a query value to each search query based on determining a frequency that each search query has been selected by a group of users. The computer system may assign a query value to each query based on determining the number of citations by the search engine of each search query. The computer system may assign a query value to each search query based on determining a time decay associated with an elapsed time from when each search query was previously used.

In some configurations, the bias is assigned based on a business rule. For example, there may be desire to promote the use of certain search queries. By increasing the bias for a particular candidate search query, the likelihood that the candidate search query is presented to a user and the sequence and/or rank in which it is presented can be increased.

The user interactions may include categories of interactions associated with at least one of the number of times that no search result candidates were selected by a group of users, the number of times that no search result candidate was read by a group of users, and the number of times that a next page of search result candidates was selected by a group of users. The computer system may assign a weight to at least one of the categories of interactions.

In another aspect, a system for generating search queries includes a user monitor arranged to monitor interactions of a user with one or more search engines. The system also includes a server arranged to: associate the user with a domain based on a purpose for using the one or more search engines, prompt the user to input a query string, the query string including a sequence of letters, and in response to receiving one or more letters of the query string from the user, generate a plurality of user selectable search query candidates. The generation of user selectable search query candidates may include assigning a query value to each search query of a set of search queries based at least in part on the user interactions with the search engine, a bias assigned to each search query, and the domain of the user. Then, the server determines the search query candidates from the set of search queries based on a range of determined query values.

In one configuration, the server receives a user selection of one of the plurality of user selectable search query candidates. The server may provide the user selection to the one or more search engines. The server may receive one or more search results from the one or more search engines and displays a portion of the search results to the user.

In certain configurations, the server generation of multiple user selectable search query candidates includes ignoring or blocking a portion of the query string based on a blocking rule set.

Various advantages and applications for using a name pronunciation system and interface in accordance with principles of the present disclosure are discussed in more detail below.

### BRIEF DESCRIPTION OF THE DRAWINGS

The above and other features of the present application, its nature and various advantages will become more apparent upon consideration of the following detailed description, taken in conjunction with the accompanying drawings, in which like reference characters refer to like parts throughout, and in which:

FIG. 1 is a diagram of a system that enables indexing and searching of information;

FIG. 2 is a functional diagram of a computer system;

FIG. 3 is a functional diagram of a system for generating search queries;

FIG. 4 is a diagram showing the typical iterative process used to search for information;

FIG. 5 is a diagram illustrating how a query value application provides suggested search queries to a search application;

FIG. 6 is a further diagram illustrating how a query value application provides additional suggested search queries to a search application;

FIG. 7 is a diagram illustrating how a search application can provide user activity information to a query value application;

FIG. 8 is a display showing a list of suggested search query candidates and a listing of search results;

FIG. 9 is a display showing a list of candidate search queries with associated query value information;

FIG. 10 is another display showing a list of candidate search queries with their determined query value and various weighted user interactions;

FIG. 11 is a plot showing the decreasing effect of time decay on a query value;

FIG. 12 is a flow diagram of a process for generating user selectable search query candidates; and

FIG. 13 is a diagram including a sequence of screen shots showing a change in candidate search queries as a user types each letter of a query string.

### DETAILED DESCRIPTION OF THE DISCLOSURE

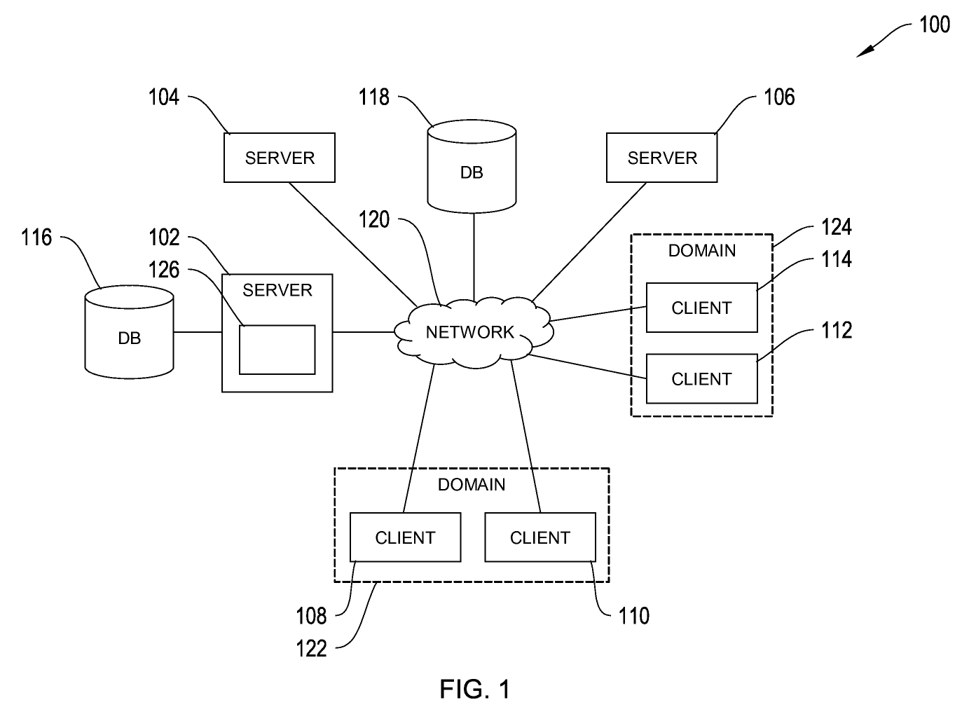

FIG. 1 is a diagram of a system 100 that enables indexing and searching of information. The system includes servers 102, 104, and 106, clients 108, 110, 112, and 114, databases 116 and 118, and network 120. The clients 108 and 110 may be associated with a first domain 122 while the clients 112 and 114 may be associated with a second domain 124.

In one configurations, server 106 includes a search engine application that accesses indexed information stored in database 118. The search engine application in server 106 may include a web server and be accessible by any one of the clients 108-114 using, for example, a web browser. The search engine application may include an Internet-based search engine such as, without limitation, Google®, Bing®, and Yahoo!®.

In certain implementations, server 104 includes a user application such as, for example, an online support application, a customer relationship management (CRM) application, a help desk application, a supply management application, a human resources support application, an business enterprise application, and so on. The user application in server 104 may include a web server and be accessible by any one of the clients 108-114 using, for example, a web browser.

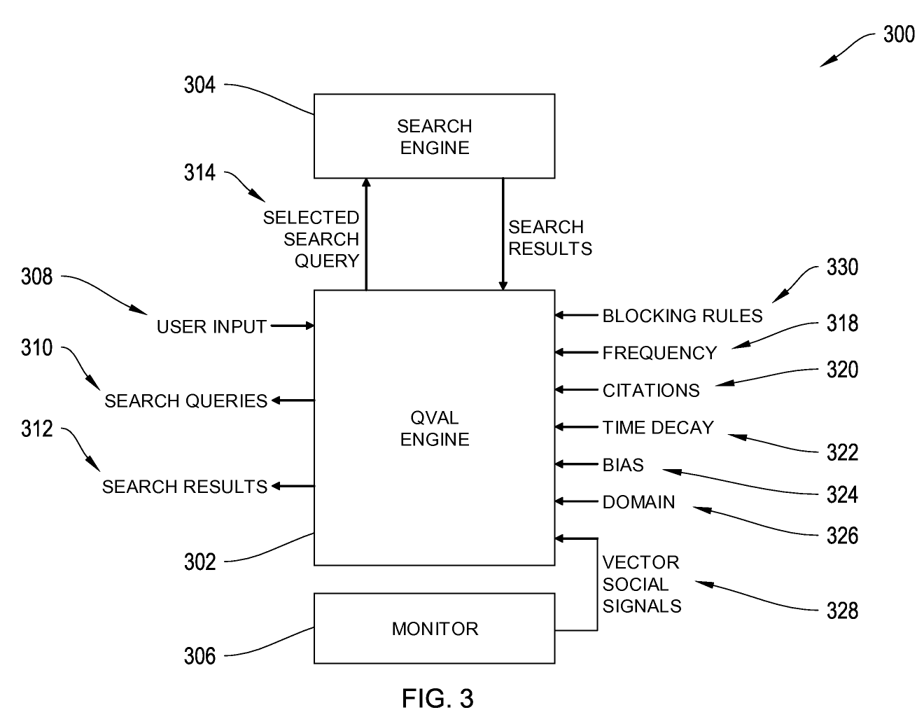

In certain implementations, server 102 includes a query value application. Further details regarding the operation of the query value application are discussed later herein with respect to FIGS. 3-13. The server 102 may interface with a local database and/or cache 116. The cache 116 may store a portion of the information stored in the database 118 to enable more efficient access to selected information from the cache 116 instead of the database 118.

The network 120 may include any suitable circuitry, device, system, or combination of these (e.g., a wireless communications infrastructure including communications towers and telecommunications servers) operative to create a communications network. Network 120 may be capable of providing communications using any suitable communications protocol. In some embodiments, network 120, servers 102-106, and clients 108-114 may support, for example, traditional telephone lines, cable television, Wi-Fi™, Ethernet, Bluetooth™, high frequency systems (e.g., 900 MHz, 2.4 GHz, and 5.6 GHz communication systems), infrared, transmission control protocol/internet protocol (“TCP/IP”) (e.g., any of the protocols used in each of the TCP/IP layers), hypertext transfer protocol (“HTTP”), BitTorrent™, file transfer protocol (“FTP”), real-time transport protocol (“RTP”), real-time streaming protocol (“RTSP”), secure shell protocol (“SSH”), any other communications protocol, or any combination thereof.

In certain implementations, servers 102, 104, and/or 106 include one or more of a LINUX, UNIX, Windows®, or MAC OS operating system. Severs 102, 104, and/or 106 may be implemented on one computer device or multiple computer devices. Database 118 and/or 116 may include one or more disk drives, solid state memory, volatile and/or non-volatile memory, an array of storage disks, and/or a plurality of redundant storage elements. Severs 102, 104, and/or 106 may include a virtual server distributed and/or copied among multiple hardware server elements.

In operation, a client such as client 108 using a web browser or other client application may initiate a request for information from a search engine in server 106. The client 108 may receive an input from a user including a search query for particular information. When the server 106 receives the query via a web server interface, the server 106 searches an index of information within database 118. The server 108 then generates a list of search results returns the list to the client 108 for display to a user. The server 108 may generate the list of search results based on certain search criteria such as popularity of requests for certain information or page rank of certain web pages.

According to an implementation of the application, a client 108 may alternatively interface with a query value application 126 in server 102 to initiate a request for information. The query value application 126 in server 102 may provide the client 108 with one or more suggested search query strings. Once a user of client 108 selects one of the suggested search queries, the selected search query may then be forwarded to the search engine application in server 106 which, in turn, returns search results to the client 108. In certain configurations, the determination of suggested search query candidates, their arrangement (e.g., sequence), and display to a user is dependent on an analysis of various factors which are discussed later herein with respect to FIG. 3.

In another implementation, a client 108 may interface with a application in server 104, such as an online support application. The online support application in server 104 may then interface with a query value application in server 102 which, in turn, interfaces with a search engine application in server 106 to provide search results to a user of client 108. In other implementations, the functions and/or applications associated with server 102, 104, and 106 may be implemented in one server or a portion of the servers, and/or distributed among the servers 102, 104, and 106.

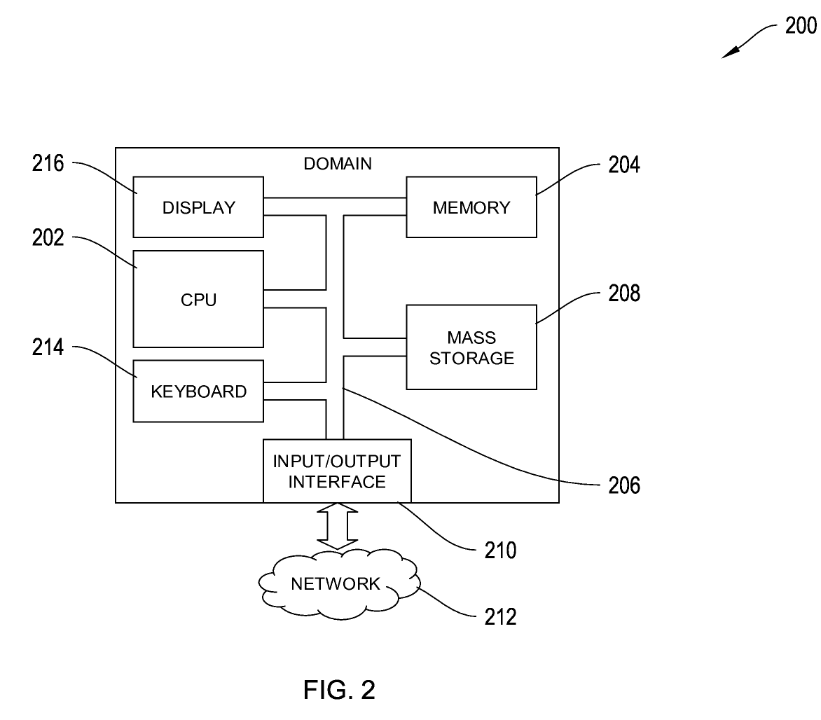

FIG. 2 includes a functional block diagram of a computer system 200, e.g., a computer, for performing the functions of any one of servers 102-106 and/or clients 108-114 of FIG. 1. The exemplary computer system 200 includes a central processing unit (CPU) 202, a memory 204, and an interconnect bus 206. The CPU 202 may include a single microprocessor or a plurality of microprocessors for configuring computer system 200 as a multi-processor system. The memory 204 illustratively includes a main memory and a read only memory. The computer 200 also includes the mass storage device 208 having, for example, various disk drives, tape drives, etc. The main memory 204 also includes dynamic random access memory (DRAM) and high-speed cache memory. In operation, the main memory 204 stores at least portions of instructions and data for execution by the CPU 202.

The mass storage 208 may include one or more magnetic disk or tape drives or optical disk drives or memory sticks, for storing data and instructions for use by the CPU 202. At least one component of the mass storage system 208, preferably in the form of a disk drive or tape drive, stores the database used for processing data, search queries, and/or search query data of the system 100. The mass storage system 208 may also include one or more drives for various portable media, such as a floppy disk, a compact disc read only memory (CD-ROM, DVD, CD-RW, and variants), or an integrated circuit non-volatile memory adapter (i.e. PC-MCIA adapter) to input and output data and code to and from the computer system 200.

The computer system 200 may also include one or more input/output interfaces for communications, shown by way of example, as interface 210 for data communications via the network 212 (or network 114). The data interface 210 may be a modem, an Ethernet card or any other suitable data communications device. To provide the functions of a server 102, 104, and/or 106 or client 108, 110, 112, and/or 114 according to FIG. 1, the data interface 210 may provide a relatively high-speed link to a network 221 (or network 120 of FIG. 1), such as an intranet, internet, or the Internet, either directly or through another external interface 210. The communication link to the network 212 may be, for example, optical, wired, or wireless (e.g., via satellite or cellular network). Alternatively, the computer system 200 may include a mainframe or other type of host computer system capable of Web-based communications via the network 212. The computer system 200 may include software for operating a network application such as a web server and/or web client.

The computer system 200 also includes suitable input/output ports, that may interface with a portable data storage device, or use the interconnect bus 206 for interconnection with a local display 216 and keyboard 214 or the like serving as a local user interface for programming and/or data retrieval purposes. The display 216 may include a touch screen capability to enable users to interface with the system 200 by touching portions of the surface of the display 216. Server operations personnel may interact with the system 200 for controlling and/or programming the system from remote terminal devices via the network 212.

The computer system 200 may run a variety of application programs and store associated data in a database of mass storage system 208. One or more such applications may include providing search query candidates as described later herein with respect to FIGS. 3-13.

The components contained in the computer system 200 are those typically found in general purpose computer systems used as servers, workstations, personal computers, network terminals, and the like. In fact, these components are intended to represent a broad category of such computer components that are well known in the art.

As discussed above, the computer system 200 may include one or more applications that provide search query candidates to a user in accordance with aspects of the application. The system 200 may include software and/or hardware that implement a web server application.

The web server application may include software such as HTML, XML, WML, SGML, PHP (Hypertext Preprocessor), CGI, and like languages.

The foregoing features of the disclosure may be realized as a software component operating in the system 200 where the system 200 is Unix workstation or other type of workstation. Other operation systems may be employed such as, without limitation, Windows®, MAC OS®, and LINUX. In some aspects, software can optionally be implemented as a C language computer program, or a computer program written in any high level language including, without limitation, C++, Fortran, Java, or Visual BASIC. Certain script-based programs may be employed such as XML, WML, PHP, and so on.

As stated previously, the mass storage 208 may include a database. The database may be any suitable database system, including the commercially available Microsoft Access database, and can be a local or distributed database system. The database can be supported by any suitable persistent data memory, such as a hard disk drive, RAID system, tape drive system, floppy diskette, or any other suitable system. The system 200 may include a database that is integrated with the system 200, however, it will be understood by those of ordinary skill in the art that in other embodiments the database and mass storage 208 can be an external element.

In certain aspects, the system 200 may include an Internet browser program and/or be configured to operate as a web server. In some embodiments, the client and/or web server may be configured to recognize and interpret various network protocols that may be used by a client or server program. Commonly used protocols include Hypertext Transfer Protocol (HTTP), File Transfer Protocol (FTP), Telnet, and Secure Sockets Layer (SSL), for example. However, new protocols and revisions of existing protocols may be frequently introduced. Thus, in order to support a new or revised protocol, a new revision of the server and/or client application may be continuously developed and released.

In one aspect, the system 100 includes a networked-based, e.g., Internet-based, application that may be configured and run on the system 200 and/or any combination of the other components of the system 100. The servers 102, 104, and/or 106 (or system 200) may include a web server running a Web 2.0 application or the like. Web applications running on the servers 102, 104, and/or 106 may use server-side dynamic content generation mechanisms such, without limitation, Java servlets, CGI, PHP, or ASP.

In certain implementations, any one of the servers 102-106 and/or clients 108-114 may include applications that employ asynchronous JavaScript+XML (Ajax) and like technologies that use asynchronous loading and content presentation techniques. These techniques may include, without limitation, XHTML and CSS for style presentation, document object model (DOM) API exposed by a web browser, asynchronous data exchange of XML data, and web browser side scripting, e.g., JavaScript. Certain web-based applications and services may utilize web protocols including, without limitation, the services-orientated access protocol (SOAP) and representational state transfer (REST). REST may utilize HTTP with XML.

Any one of the servers 102-106 and/or clients 108-114 may also provide enhanced security and data encryption. Enhanced security may include access control, biometric authentication, cryptographic authentication, message integrity checking, encryption, digital rights management services, and/or other like security services. The security may include protocols such as IPSEC and IKE. The encryption may include, without limitation, DES, AES, RSA, and any like public key or private key based schemes.

FIG. 3 is a functional diagram of a system 300 for generating search queries. The system 300 includes a query value engine 302, a search engine 304, and a user monitor 306. The query value engine 302 may be included in a function and/or application running on a server such as the query value application 126 on server 102 of FIG. 1.

The query value engine 304 may receive one or more user inputs 308 from a client such as client 108 and, in response, send one or more search queries 310 and/or search results 312 to the client 108. The suggested search queries 310 may be based on one or more factors that are inputted and/or retrieved by the query value engine 302 including, without limitation, frequency 318, citations 320, time decay 322, bias 324, domain 326, blocking rules 330, and a vector of social signals 328.

In certain implementations, the one or more user inputs 308 include one or more letters of a query string from the user. For example, as a user types each letter of the query string “iPad battery,” the query value engine 302 dynamically generates a list of search query candidates and provides the list as search queries 310 to a user client 108. When the user selects one of the candidate search queries 310, the query value engine 302 sends the selected search query 314 to one or more search engines such as search engine 304. The one or more search engines such as search engine 304 returns search results 316 to the query value engine 316. Then, the query value engine 302 provides the search results 312 to the user client 108 for viewing by the user. The query value engine 302 generates one or more lists of candidate search queries 301 based on various factors 318-328 which will be discussed in more detail later herein.

The search engine 304 may be included in an application and/or function located in the same server as the query value engine 302 or in a remote server such as server 106 in FIG. 1. The search engine 304 may include a web server and be accessible by any one of the clients 108-114 using, for example, a web browser. The search engine 304 may include an Internet-based search engine such as, without limitation, Google®, Bing®, and Yahoo!®.

The monitor 306 may be included in an application and/or function located in the same server as the query value engine 302, in a remote server such as server 106 in FIG. 1, in one or more clients 108-114 of FIG. 1, or a combination thereof. In certain configurations, the monitor 306 monitors user interactions with the query value engine 302 and/or search engine 304. The monitor may also monitor the interactions of a group of users with the query value engine 302 and/or search engine 304. Based on the monitored interactions, the monitor 306 may generate a vector of social signals 328 as an input to the query value engine 302 for generating candidate search queries 310.

The vector of social signals 328 may be based on various factors including, without limitation, the number of times that no search results (i.e., hits) were selected by a user and the user selected another search, the number of times that no search results were read for a period of time (e.g., for greater than 3 seconds), and the number of times that a user selected the next page of search results. Each factor of the vector 328 may be weighted so that one or more factors have greater or lesser significance than other factors. In one configuration, the weight value has a range of 0.0 to 1.0.

In one configuration, the vector of social signals 328 is calculated as follows:

Vector=[noHClick*w1+noHRead*w2+NextPage*w3] (1)

Where:
noHClick=# times no hits were selected−user submitted another search
noHRead=# times no hits were read (time>3 Seconds)
NextPage=# times next page was selected
w1, w2, w3=weight values

In certain implementations, the query value engine 302 determines a query value associated with one or more search query strings. The query value associated with each search query string may be generated based on one or more factors including frequency 318, citations 320, time decay 322, bias 324, domain 326, blocking rules 330, and the vector of social signals 328. The query value engine 302 may gather information regarding the one or more factors or receive the information regarding the one or more factors from a source such as, for example, monitor 306 or a remote server and/or one or more clients 108-114.

Frequency 318 may be based on how many times a search query 314 was used in a search among a group of users. A group of users may be associated with a particular domain 326. Thus, query value engine 302 can determine more relevant and/or appropriate candidate search queries 310 for a particular group of users assigned to a particular domain 326. The domain 326 may be based on a purpose for using the query value engine 302. For example, a group of users may be customer care representatives providing on-line support for customers with questions regarding a company's products and/or services. By identifying the domain 326 of the customer care representatives, the query value engine 302 can evaluate potential search queries based on their relevance to on-line support issues. Domain 326 may be specified for other purposes such as, without limitation, human resource support, on-line support for different products and services, call center support, consulting for personal, technical, financial, and social topics. In some configurations, a user can specify their associated domain 326 via a browser client application running on, for example, client 108. The domain 326 identifier may then be sent to the query value engine 302 from the client 108.

Citations 320 may be based on how many times a particular search query 310 was suggested to a user over a period of time. The number of user rejections may be determined by subtracting the frequency 318 from citations 320 over a period of time.

Time decay 322 may be based on the elapsed time from when a particular search query 314 was used and/or selected by a user. The elapsed time may be calculated, for example, by time decay function such as (weeks)^{-0.5}. Bias 324 may be a business controlled value that enables a business to increase or decrease the query value associated with a particular search query. The bias 324 may enable a business to promote certain search queries 310 for use by users by increasing the bias 324 associated with the search queries 310. The query value engine 302 may use blocking rules to ignore or block query value strings from the query value determination process. For example, offensive words and/or strings or strings with typographical errors may not be considered.

In certain implementations, the query value engine 302 assigning a query value to one or more search queries of a set of search queries based on one or more of the factors 318-330 and provides a list of candidate search queries 310 from the set of search queries based on a range of determined query values.

In one configuration, the query value engine 302 uses the following formula to calculate a query value (QVal):

QVal=((1+b²)*Pr(yes)*Pr(no))/(b²*Pr(no)+Pr(yes))*time decay*bias (2)

Where:
Pr(yes)=useful frequency/citations
Pr(no)=(citations−frequency)/citations
Useful frequency=frequency−vector of social signals
Frequency=# times a query was used in a search among all users of a group
Time decay=elapsed time since a search query was selected by a user (weeks)^{0.5}
Bias=business controlled value=default=1
Vector of social signals=see formula (1)
b=value set by the query value engine

In another configuration, the query value engine 302 uses the following formula to calculate a query value (QVal):

QVal=Pr(yes)*time decay*bias (3)

By determining a query value associated with each of the possible search queries that can be presented to a user, the query value engine 302 can rank the possible search queries based on their query values and, thereby, determine which candidate search queries 310 to send to a client 108 for display to a user. For example, the query value engine 302 may select a set of candidate search queries with the highest query values. The query value engine 302 may select a set of 1, 2, 3, 5, 10, 20, and so on of search queries having the highest query values for presentation to a user.

Thus, instead of providing candidate search queries to a user based simply on a histogram, as done by existing search engines, the query value engine 302 advantageously predicts the most relevant and/or likely needed candidate search queries for a user which substantially reduces search time and makes the search process substantially more efficient.

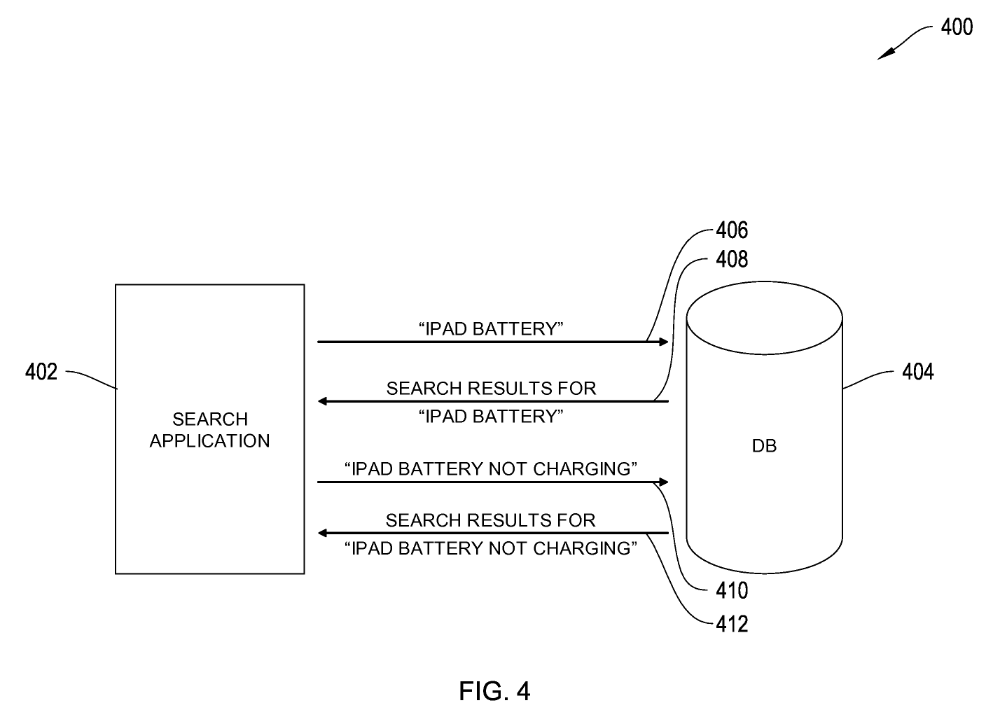

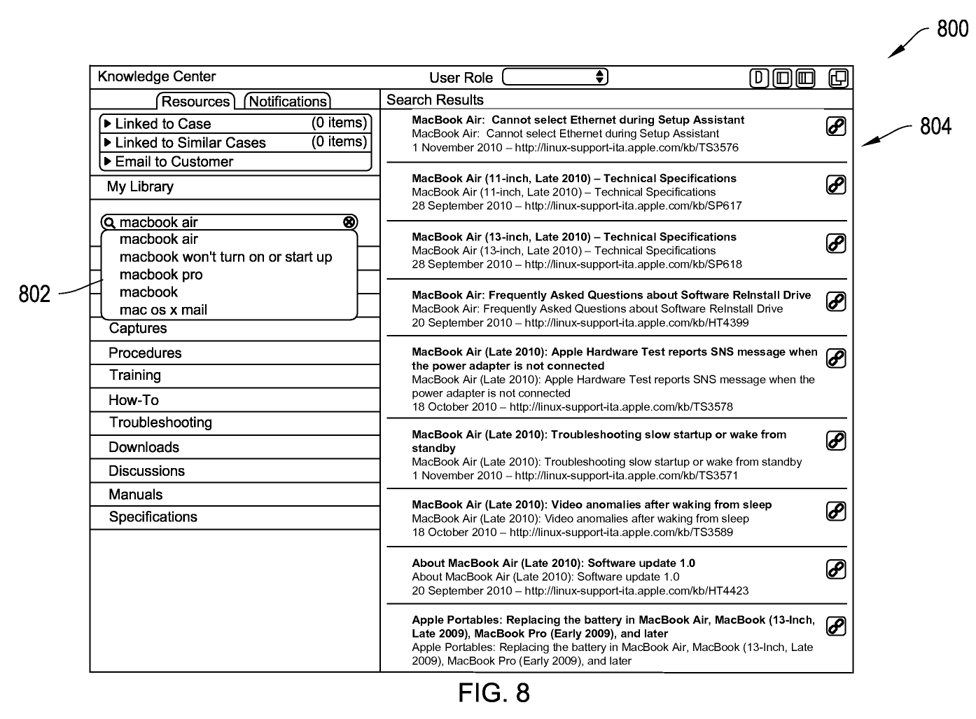

FIG. 4 is a diagram showing the typical iterative process 400 used to search for information. Typically, a user accesses a search application 402 via their web browser to initiate a search for certain information. In FIG. 4, the user initially requests information using the search query string “iPad battery.” The search application 402 sends a search query 406 for “iPad Battery” to a data store and/or database 404 that includes an index of searchable information. The database 404 responds with search results 408 for “iPad battery.” The search results 408 are then presented to the user via their web browser as a list of search results such as shown in FIG. 8 on one or more results pages. Currently, the user reviews the search results and, if the desired result is not listed, the user must initiate another search.

In the example of FIG. 4, the user initiates a second search by providing a search query for “iPad battery not charging.” The search application 402 sends the search query 410 “iPad battery not charging” to the database 404 which responds by sending search results 412 to the search application 402 for display to the user. Unfortunately, the iterative process 400 of FIG. 4 can be time consuming and costly for certain applications.

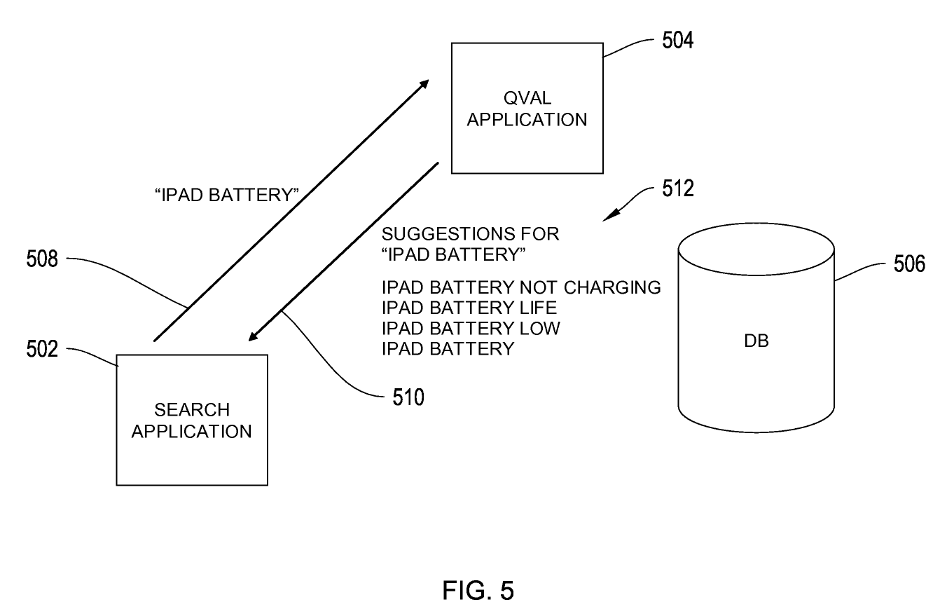

FIG. 5 is a diagram of a process 500 illustrating how a query value application provides suggested search queries to a search application 502. A search application 502 may include an application that initiates a search such as, for example, a user's browser, a customer service application, on-line help application, human resources application, or any application capable of allowing a user to search a database of information.

Instead of querying the database 506 directly, the search application 502 may send a search query 508 “iPad battery” to query value application 504. The query value application may include the query value engine 302 of FIG. 3. The query value application 504 may then determine a list of suggested search queries 512 and send the results 510 including the search queries 512 to the search application 502 for display to a user. In certain configurations, the query value application 502 dynamically provides different lists of suggested search queries as the user types each letter of the search string “iPad battery” and, thereby, provides immediate feedback to the user of potentially relevant and desirable candidate search queries 310. The user may select one of the candidate search queries 310 to initiate a search in database 506 or the user may continue to type additional letters to refine the list of candidate search queries 310. Alternatively, the user may select one the candidate search queries 310 and receive a subsequent list of candidate search queries 310 related to the previously selected candidate.

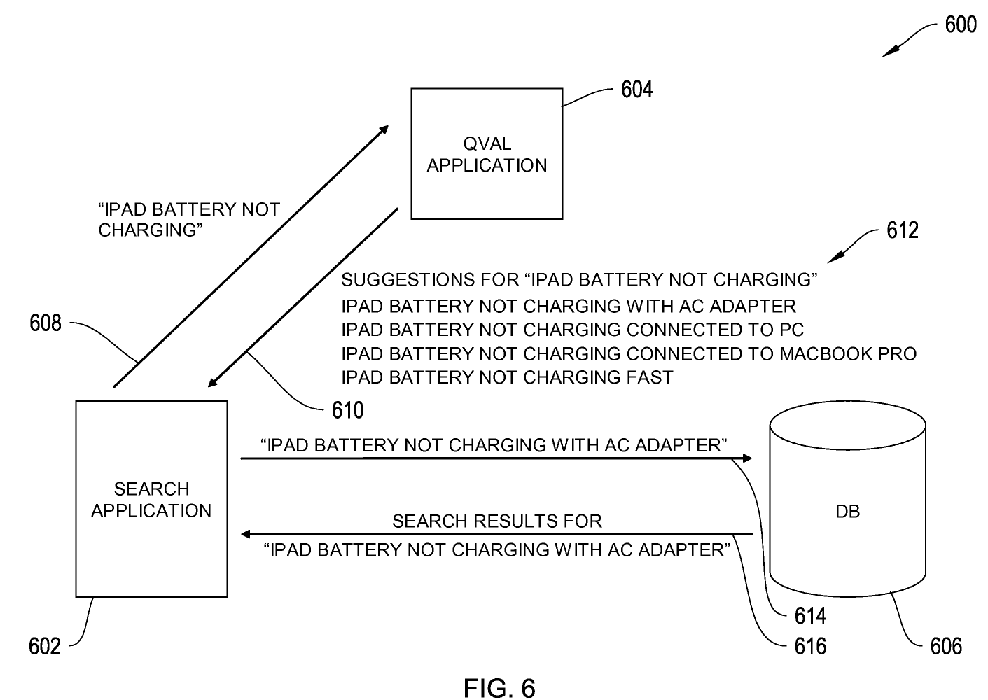

FIG. 6 is a diagram of a process 600 continuing from the process 500 that illustrates how a query value application 604 provides additional suggested search queries to a search application 602. Upon viewing the list of suggested search queries 512 in FIG. 5, the user may then enter the search query string “iPad battery not charging” via the search application 602. The search application 602 may then send the search query 608 “iPad battery not charging” to the query value application 604. Based on the determined query value for a set a candidate search queries, the query value application 604 provides search results 610 including a list of suggested search queries 612 to the search application 602. Upon viewing the updated list of suggested search queries 612, the user can then select a more relevant and/or desired search query 314. The search application 602 can then send the search query 614 “iPad battery not charging with AC adapter” to the database 606. In response, the database 606 sends more relevant search results 616 to the search application 602 for display to the user.

Thus, instead of requiring the user to iteratively send search queries to a database 404 and review search results, the query value application 504 and/or 604 enable the user to more immediately determine a more relevant and/or desirable search query before sending the search query to a search engine or database 606. This capability is particularly advantageous for on-line support where the amount of time consumed to identify an appropriate solution and/or answer to a problem can be substantially reduced by eliminating repetitive search by on-line support personnel. In certain instances, the amount of time required to search and select the proper information has been reduced from 18 seconds (based on the process in FIG. 4) to about 11 seconds (based on the process of FIGS. 5 and 6), resulting in about a 39 percent reduction in time to select the appropriate result. For a help desk service and like services where personnel initiate many searches, the saving in time and costs is substantial.

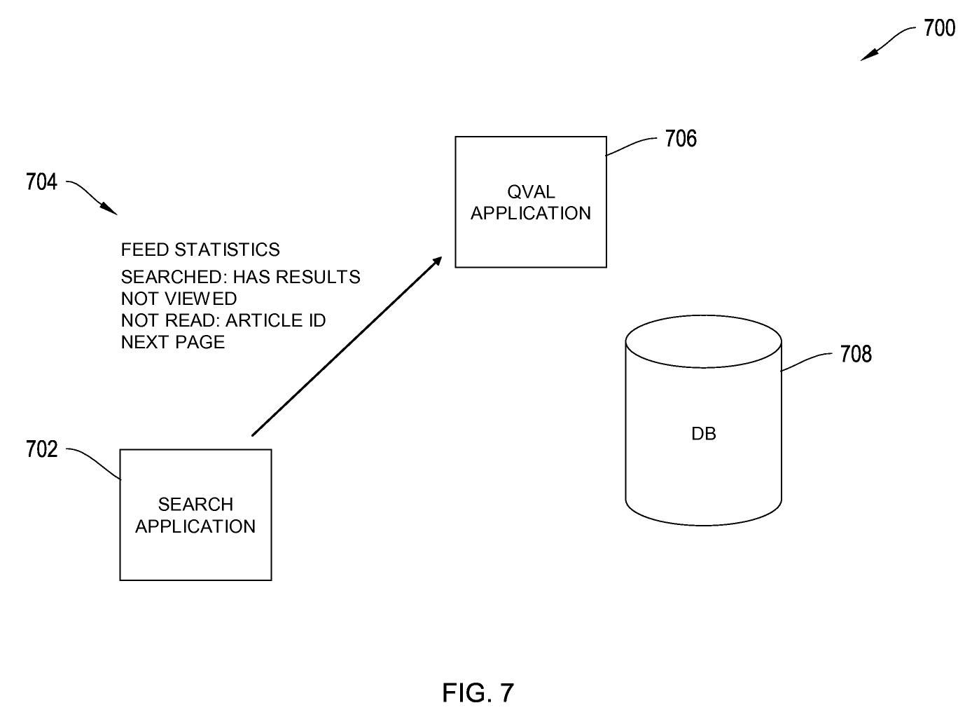

FIG. 7 is a diagram of a process 700 illustrating how a search application 702 can provide user activity information 704 to a query value application 706. As discussed previously, a search application may include a user's web browser located in a client 108, a search engine such as search engine 304, an enterprise application such as an on-line help application, human resources application, and so on, as well as any other application that enables a user to search a database 708 for information. The search application 702 may include a monitor 306 or a portion of a monitor 306 and, thereby, send user activity information 704 to the query value application 706. The user activity information may include data used to determine the vector of social signals 328 and/or feed statistics such as the number of times that no search results (i.e., hits) were selected by a user and the user selected another search, the number of times that no search results were read for a period of time (e.g., for greater than 3 seconds), and the number of times that a user selected the next page of search results.

FIG. 8 is a display 800 showing a list of suggested search queries 804 and a list of search results 806. The list of suggested search queries 804 may include, for example, the list of search queries 310 generated by the search engine 302 of FIG. 3. The list of search results 806 may include, for example, the search results 312 and/or 316 of FIG. 3.

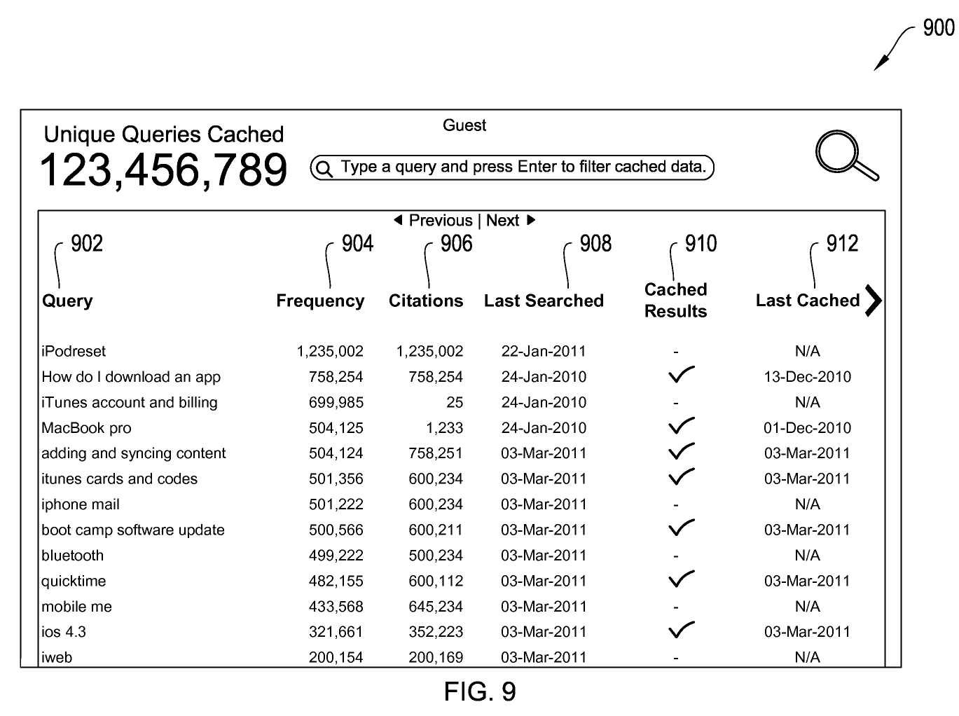

FIG. 9 is a display 900 showing a list of candidate search queries 902 with associated query value information including frequency 904, citations 906, the last time a search query was searched and/or selected 908, whether a search query was cached 910, and when a search query was last cached 912. In certain implementations, the query value engine 302 caches certain search queries and/or associated search results to enable more efficient retrieval of such information without the need to send a query and wait for associated search results from a search engine. The cached search queries and/or associated resulted may be stored in a cache such as database 116 of FIG. 1.

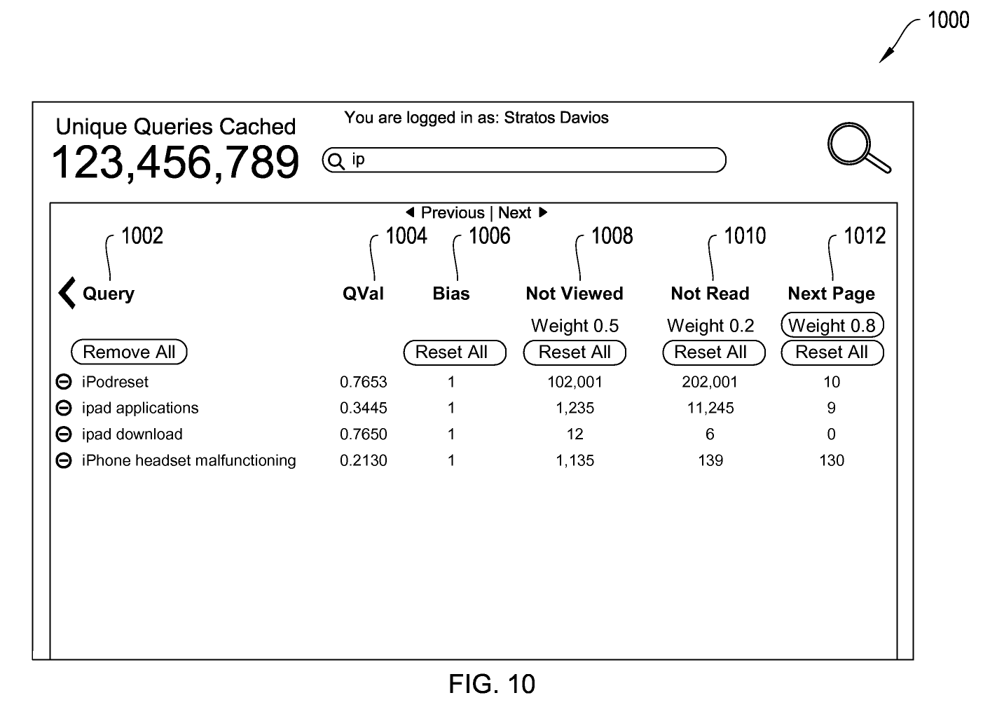

FIG. 10 is another display 1000 showing a list of candidate search queries 1002 with their determined query value (QVal) 1004, bias 1006, and various weighted user interactions including Not Viewed 1008, Not Read 1010, and Next Page 1012. The QVal 1004 may be generated by query value engine 302 of FIG. 3. Bias 1006 may include bias 324 of FIG. 3. Not Viewed 1008, Not Read 1010, and Next Page 1012 may be used to determine the vector of social signals 328 of FIG. 3.

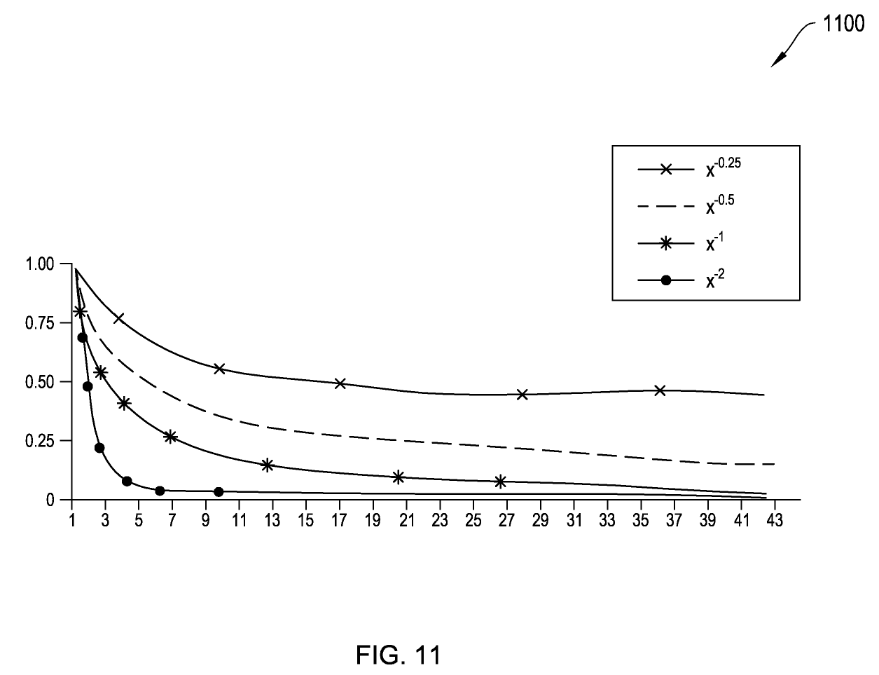

FIG. 11 is a plot 1100 showing the decreasing effect of time decay at various settings on a query value. The time decay of FIG. 11 may include the time decay 322 of FIG. 3.

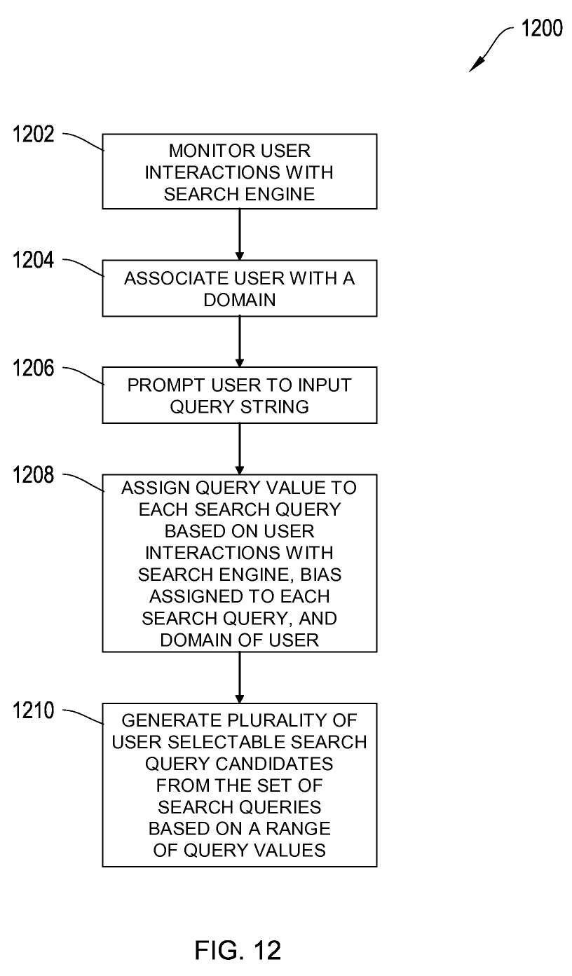

FIG. 12 is a flow diagram of a process 1200 for generating user selectable search query candidates. A system for generating search queries may include a query value engine such as query value engine 302 of FIG. 3. The engine 302 may be implemented on a computer such as computer system 200 using a computer readable medium that is operatively coupled to the computer system 200. The computer readable medium may store program codes causing the computer system 200 to perform functions such as: monitoring interactions of a user with a search engine 304 (Step 1202), associate the user with a domain 326 based on a purpose for using the search engine 304 (Step 1204), prompt the user to input a query string where the query string including a sequence of letters (Step 1206), and in response to receiving one or more letters of the query string from the user, generate a plurality of user selectable search query candidates 310. In generating the user selectable search query candidates 310, the computer system 200 and/or processor 202 assigns a query value to each search query of a set of search queries based at least in part on the user interactions with the search engine, a bias assigned to each search query, and the domain of the user (Step 1208). In one configuration, the system 200 and/or processor 202 assigns a query value to each search query after and/or in real-time as the user enters the query string. In another configuration, the system 200 and/or processor 202 assigns a query value to each search query before the user enters the query string. Thus, the system 200 and/or processor may pre-calculate and store query values associated with search query candidates for a selected period of time. Then, the system 200 determines the plurality of search query candidates from the set of search queries based on a range of determined query values (Step 1210).

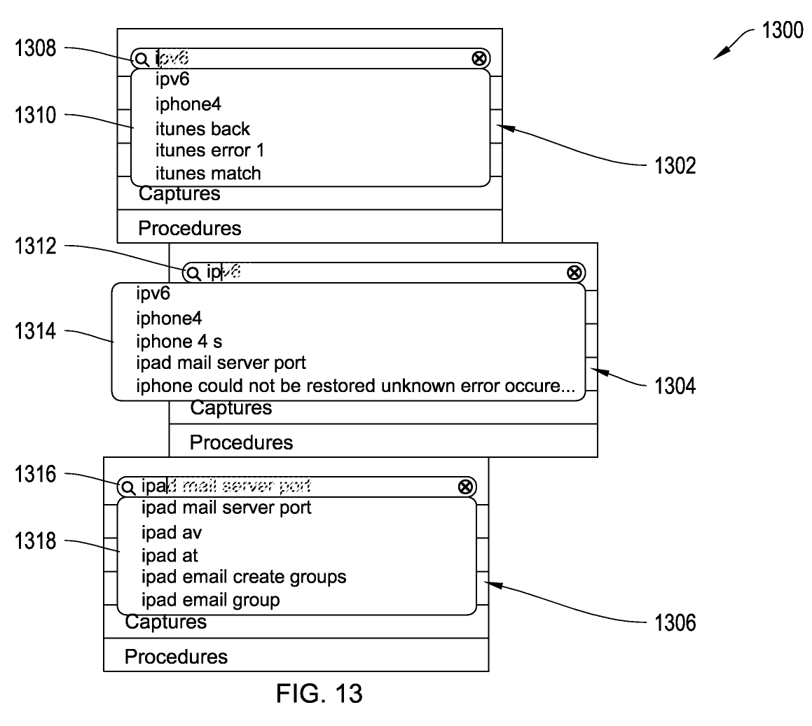

FIG. 13 shows a sequence of screen shots 1302, 1304, and 1306 illustrating a change in candidate search queries as a user types each letter of a query string. Screen shot 1302 displays the query string 1308 for the letter “I” along with the resulting list 1310 of search query candidates based on query values generated by query value engine 302. Screen shot 1304 displays the query string 1312 for the letters “Ip” along with the resulting list 1314 of search query candidates based on query values generated by query value engine 302. Screen shot 1306 displays the query string 1316 for the letters “Ipa” along with the resulting list 1318 of search query candidates based on query values generated by query value engine 302. Thus, as a user types the letters of a query string, the system 300 dynamically generates a list of search query candidates for user selection.

It will be apparent to those of ordinary skill in the art that the systems and methods involved in the present application may be embodied in a computer program product that includes a computer usable, non-transitory, and/or readable medium. For example, such a computer usable medium may consist of a read only memory device, such as a CD ROM disk or conventional ROM devices, or a random access memory, such as a hard drive device or a computer diskette, or flash memory device having a computer readable program code stored thereon.

It is understood that the various features, elements, or processes of the foregoing figures and description are interchangeable or combinable to realize or practice the implementations describe herein. Those skilled in the art will appreciate that aspects of the application can be practiced by other than the described implementations, which are presented for purposes of illustration rather than of limitation, and the aspects are limited only by the claims which follow.

What is claimed is:

1. A method for generating search queries comprising:
monitoring interactions of a user with a search engine;
associating the user with a domain based on a purpose for using the search engine;
prompting the user to input a query string, the query string including a sequence of letters;
in response to receiving one or more letters of the query string from the user, generating a plurality of user selectable search query candidates; wherein generating includes:
assigning a query value to each search query of a set of search queries based at least in part on the user interactions with the search engine, a bias assigned to each search query, and the domain of the user; and
determining the plurality of search query candidates from the set of search queries based on a range of determined query values.

2. The method of claim 1 comprising receiving a user selection of one of the plurality of user selectable search query candidates.

3. The method of claim 2 comprising providing the user selection to the search engine.

4. The method of claim 3 comprising receiving one or more search results from the search engine and displaying a portion of the search results to the user.

5. The method of claim 1, wherein assigning a query value to each query includes determining a frequency that each search query has been selected by a group of users.

6. The method of claim 1, wherein assigning a query value to each query includes determining the number of citations by the search engine of each search query.

7. The method of claim 1, wherein assigning a query value to each search query includes determining a time decay associated with an elapsed time from when each search query was previously used.

8. The method of claim 1, wherein the bias is assigned based on a business rule.

9. The method of claim 1, wherein the user interactions include categories of interactions associated with at least one of the number of times that no search result candidates were selected by a group of users, the number of times that no search result candidate was read by a group of users, and the number of times that a next page of search result candidates was selected by a group of users.

10. The method of claim 9 comprising weighting at least one of the categories of interactions.

11. A system for generating search queries comprising:
a computer;
a computer readable medium, operatively coupled to the computer, the computer readable medium storing program codes causing the computer to perform functions comprising:
monitoring interactions of a user with a search engine;
associating the user with a domain based on a purpose for using the search engine;
prompting the user to input a query string, the query string including a sequence of letters;
in response to receiving one or more letters of the query string from the user, generating a plurality of user selectable search query candidates; wherein generating includes:
assigning a query value to each search query of a set of search queries based at least in part on the user interactions with the search engine, a bias assigned to each search query, and the domain of the user; and
determining the plurality of search query candidates from the set of search queries based on a range of determined query values.

12. The system of claim 11, wherein the computer receives a user selection of one of the plurality of user selectable search query candidates.

13. The system of claim 12, wherein the computer provides the user selection to the search engine.

14. The system of claim 13, wherein the computer receives one or more search results from the search engine and displays a portion of the search results to the user.

15. The system of claim 11, wherein assigning a query value to each query includes determining a frequency that each search query has been selected by a group of users.

16. The system of claim 11, wherein assigning a query value to each query includes determining the number of citations by the search engine of each search query.

17. The system of claim 11, wherein assigning a query value to each search query includes determining a time decay associated with an elapsed time from when each search query was previously used.

18. The system of claim 11, wherein the bias is assigned based on a business rule.

19. The system of claim 11, wherein the user interactions include categories of interactions associated with at least one of the number of times that no search result candidates were selected by a group of users, the number of times that no search result candidate was read by a group of users, and the number of times that a next page of search result candidates was selected by a group of users.

20. The system of claim 19, wherein the computer assigns a weight to at least one of the categories of interactions.

21. A system for generating search queries comprising:
a user monitor arranged to monitor interactions of a user with one or more search engines; and
a server arranged to:
associate the user with a domain based on a purpose for using the one or more search engines;
prompt the user to input a query string, the query string including a sequence of letters;
in response to receiving one or more letters of the query string from the user, generate a plurality of user selectable search query candidates; wherein generating includes:
assigning a query value to each search query of a set of search queries based at least in part on the user interactions with the search engine, a bias assigned to each search query, and the domain of the user; and
determining the plurality of search query candidates from the set of search queries based on a range of determined query values.

22. The system of claim 21, wherein the server receives a user selection of one of the plurality of user selectable search query candidates.

23. The system of claim 22, wherein the server provides the user selection to the one or more search engines.

24. The system of claim 23, wherein the server receives one or more search results from the one or more search engines and displays a portion of the search results to the user.

25. The system of claim 21, wherein generating a plurality of user selectable search query candidates includes ignoring or blocking a portion of the query string based on a blocking rule set.
